(19) United States
(12) Patent Application Publication
(10) Pub. No.: US 2020/0331734 A1
(43) Pub. Date: Oct. 22, 2020

(54) INDUSTRIAL VEHICLE

(71) Applicant: NOBLELIFT INTELLIGENT EQUIPMENT CO., LTD., Zhejiang (CN)

(72) Inventors: Xuejun ZHOU, Zhejiang (CN); Zhiyu ZHANG, Zhejiang (CN); Xiaodong LIU, Zhejiang (CN); Linqiang SHI, Zhejiang (CN)

(73) Assignee: NOBLELIFT INTELLIGENT EQUIPMENT CO., LTD., Zhejiang (CN)

(21) Appl. No.: 16/960,715

(22) PCT Filed: Dec. 19, 2018
(86) PCT No.: PCT/CN2018/121953

§ 371 Date: Jul. 8, 2020

(30) Foreign Application Priority Data
Jul. 25, 2018 (CN) 201810823940.9
Jul. 25, 2018 (CN) 201810823941.3
Sep. 13, 2018 (CN) 201811069067.5

(51) Int. Cl. B66F 9/075; B66F 9/22; B66F 9/24

(52) U.S. Cl. CPC B66F 9/07572; B66F 9/24; B66F 9/22

(57) ABSTRACT

Disclosed is an industrial vehicle, which includes a handle (32), a main vehicle frame (2), and a drive wheel assembly (33), a vertical column (1) being mounted on the main vehicle frame (2), the vertical column (1) comprising an upper top plate (11) and a back plate (13) connected to the upper top plate (11); the industrial vehicle also includes a controller (52), a pump station (53), and a jacking device (51) that abuts against the upper top plate (11); in the horizontal direction, the jacking device (51) is farther from the handle (32) than the drive wheel assembly (33). The foregoing industrial vehicle has high stability and stable lifting, optimizes the positional relationships of each component of the vehicle, and has a shorter vehicle body, such that a smaller turning radius is thus obtained.

### TECHNICAL FIELD

The disclosure relates to the field of automated machinery and equipment, in particular to an industrial vehicle.

### BACKGROUND

Industrial vehicles refer to power-driven motor vehicles used for handling, pushing, pulling, lifting, stacking or placing various goods. Common industrial vehicles may include forklifts, side forklifts, tractors, pallet trucks, stackers, etc.

The structure of industrial vehicles often includes a body, one or more handles, one or more forks, a battery box, an oil cylinder, a pump station, a controller and other elements. Among them, the oil cylinder may be connected to the body, the body may be connected to the fork. When the piston rod in the oil cylinder may be ejected, the body and fork may be driven to lift.

First of all, the elements such as the pump station, the controller, the oil cylinder and the battery may be lined up in a row, occupying a larger body length space. In order to obtain a smaller turning radius, the current industrial vehicles with smaller and more compact body design may be more suitable for narrow roadway environment operations.

Secondly, a wiring harness needs to be connected between the drive wheel and the controller to realize the transmission of electrical signals. In the prior art, since the space above the drive wheel may be often an oil cylinder. On one aspect, a third-party lead element may be needed to drive the cable to wind out from the drive wheel, on the other aspect, in order to adapt to the space arrangement of the cylinder and the controller, the cable needs to be bent and connected after being wound out of the drive wheel, the cable may be easy to be depreciated and worn. Because the battery may be located in the frame, the controller and the oil pump in the prior art will rotate relative to the battery when they follow the drive wheel, and they will also rotate relative to the rotary shaft hole above the drive wheel, and the cable will be greatly bent with elongation shortened.

### SUMMARY

The object of the present disclosure may be to provide an industrial vehicle with high stability and stable lifting, it has optimized design of the positional relationship of various elements of the vehicle, with a shorter body design to obtain a smaller turning radius.

The above technical object of the present disclosure may be achieved by the following technical solution: an industrial vehicle including a handle, a main frame and a drive wheel assembly, wherein the main frame may be installed with a column body, and the column body may include an upper roof plate. This type of industrial vehicle may also include a controller, a pump station, and a jacking device that abut against the upper roof plate; in a horizontal direction, the jacking device may be farther away from the handle than the drive wheel assembly.

In embodiments of the present disclosure, the jacking device may be an oil cylinder.

In an example of the present disclosure, the cylinder axis of the oil cylinder may be farther away from the handle in the horizontal direction than the center line of the drive wheel of the drive wheel body of the drive wheel assembly.

In an example of the present disclosure, the handle may be directly connected to the drive wheel assembly.

In an example of the present disclosure, the controller, the pump station and the jacking device may be installed on a drive wheel frame, the drive wheel frame may be connected to the column body through a hinge structure, and the top of the jacking device may abut against the upper roof plate.

In an example of the present disclosure, the controller may be located above the drive wheel assembly, the drive wheel assembly may be connected to the controller through a drive wheel wiring harness, and the drive wheel wiring harness may derive from the rotary shaft hole at the upper position of the drive wheel assembly, the axis of the rotary shaft hole may be concentric with the rotation center line of the drive wheel assembly, and the rotary shaft hole may be located on the drive wheel frame.

In an example of the present disclosure, the drive wheel assembly may include a drive wheel frame, and the drive wheel frame may be mounted with bearings that are double bearings distributed upside and downside.

In an example of the present disclosure, the drive wheel assembly may include a drive wheel frame, and the bearing mounted on the drive wheel frame may be a single double-row bearing.

In an example of the present disclosure, the handle may be connected to the drive wheel assembly, and the controller, the pump station and the jacking device may be connected to the column body.

In an example of the present disclosure, a battery box body may be further included, and the battery box body may be installed and connected to the column body.

In an example of the present disclosure, the distance between the controller and the back plate may be the same as that between the pump station and the back plate.

In an example of the present disclosure, a side of the back plate away from the jacking device may be provided with a back reinforcement plate connected to the main frame, and two side plates may be connected to the upper roof plate and the back plate together.

In an example of the present disclosure, a fork may be connected to the main frame, and the fork may be located on a side of the column body away from the handle.

In an example of the present disclosure, the two side plates, the upper roof plate, and the back plate may form a semi-enclosed space, and the jacking device may be mounted in the semi-enclosed space.

In an example of the present disclosure, a cover may be further included. The cover, the two side plates, the upper roof plate and the back plate may form an installation space for the controller, the pump station, and the jacking device.

In an example of the present disclosure, the battery box body may include a retention slot at the bottom, the back reinforcement plate may be used to extend into the retention slot, a slide rail groove may be opened in the retention slot, and the back reinforcement plate may be provided with a guide rail, and the guide rail can slide in the slide rail groove.

In an example of the present disclosure, the battery box body may be provided with a slide-in slope near the retention slot, the slide-in slope may be inclinedly provided, and a guide slope may be provided at the uppermost position of the guide rail, and the inclination angle of the guide slope may match that of the slide-in slope.

In summary, the present disclosure has the following beneficial effects:

1. The oil cylinder and the drive wheel may be placed eccentrically, the axis lines thereof do not coincide, the oil cylinder may be closer to the direction of the fork, the space arrangement may be optimized, and the overall length of the vehicle may be reduced.

2. Due to the eccentric arrangement of the oil cylinder, the space above the drive wheel may be not occupied naturally, which may be conducive to the wiring and connection of the drive wheel wiring harness.

3. The pump station, the controller and the jacking device may be not used as rotating parts, but as static parts, with less wear and tear, and may be not prone to malfunction or damage.

4. If the pump station, the controller and the jacking device may be not rotated, they will not be easy for the operator to make hands hurt.

5. Since the pump station, the controller and the jacking device do not rotate relative to the battery box body, the interconnected cables between the various elements remain relatively stationary, and the cables may be not easily broken or damaged.

6. The elements such as the jacking device, the controller and the pump station may be not visible on the outside, and the overall aesthetics of the vehicle may be improved.

7. Under the lever effect, the distance between the contact point and the back plate may be shorter, the force arm may be shorter, and the stability of the entire upper roof plate may be stronger. The upper roof plate may be less likely to be lifted to cause tilt or damage.

8. The body length of the entire vehicle may be shortened, such that the vehicle has a smaller turning radius.

9. The side plate and back plate further enhance the structural strength of the column.

10. The back reinforcement plate can slide into the retention slot to fix the battery box and improve the stability of the battery box during operation.

11. Through the guide rail and the slide rail groove, it may be convenient and labor-saving to install and remove.

12. The guide slope and the sliding slope cooperate with each other, the installation accuracy may be high, and the installation efficiency may be fast.

### BRIEF DESCRIPTION OF THE DRAWINGS

FIG. 1 is a schematic diagram of Embodiment 1;

FIG. 2 is a schematic diagram of the hidden cover of FIG. 1;

FIG. 3 is a schematic view of FIG. 2 from another angle;

FIG. 4 is a schematic view of FIG. 2 from another angle;

FIG. 5 is an enlarged detail view at A in FIG. 4;

FIG. 6 is a schematic diagram of the battery box body;

FIG. 7 is a schematic diagram of FIG. 6 from another angle;

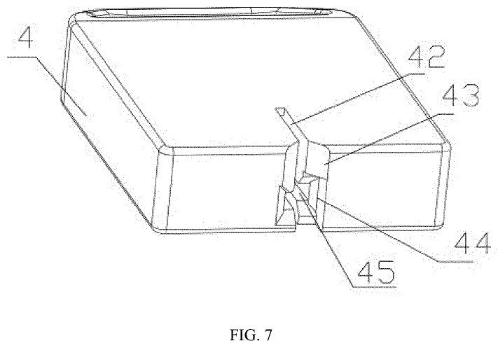

FIG. 8 is a schematic diagram of the prior art;

FIG. 9 is a schematic diagram of the prior art;

FIG. 10 is a side view of Embodiment 1.

In the drawings:

1—column body, 11—upper roof plate, 12—side plate, 13—back plate, 15—cover, 16—back reinforcement plate, 17—guide rail, 171—guide slope;

2—main frame, 21—battery cover plate;

31—fork, 32—handle, 33—drive wheel assembly, 331—drive wheel frame; 4—battery box body, 41—handle slot, 42—retention slot, 43—slide-in slope, 44—slide rail groove, 45—connector opening, 51—jacking device, 52—controller, 53—pump station, 6—drive wheel wire harness, L1—drive wheel center line, L2—cylinder axis.

### DETAILED DESCRIPTION OF EMBODIMENTS

The present disclosure will be further described in detail below with reference to the drawings.

This specific embodiment is merely an explanation of the present disclosure, and it is not a limitation of the present disclosure. Those skilled in the art can make modifications without creative contribution to this embodiment after reading this specification, as long as they is protected in the present disclosure within the scope of the requirements by patent law.

### Embodiment 1

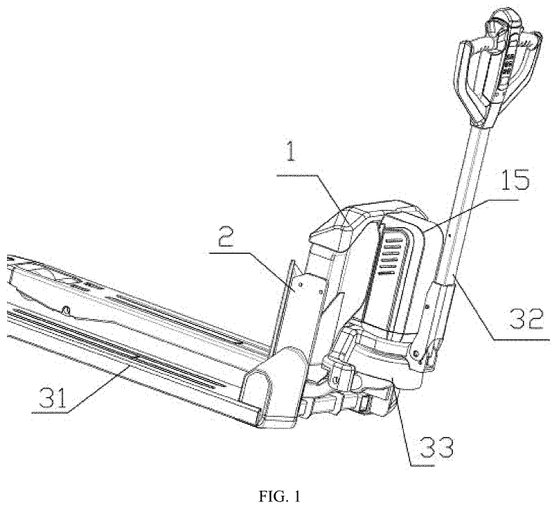

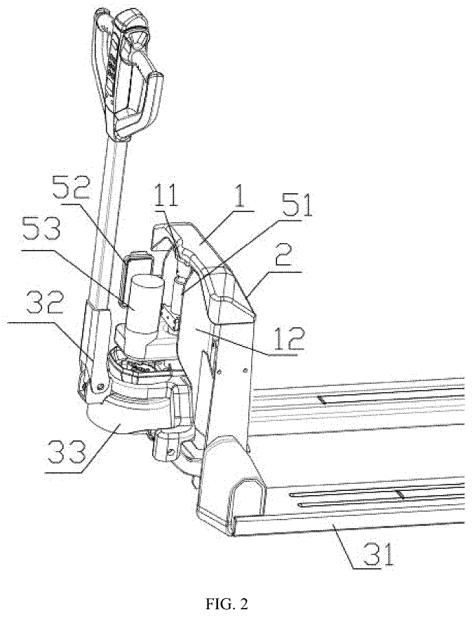

As shown in FIGS. 1 and 2, an industrial vehicle may be different types of vehicles such as a forklift, a stacker, and a sorter etc. The technical solution uses a forklift as an example. It may include a main frame 2, the entire vehicle can be roughly divided into two assembly units, where assembly A may include a handle 32 and a drive wheel assembly 33. Unlike the prior art, the handle 32 may be directly connected to the drive wheel assembly 33, instead of connecting via the pump station bracket or the main frame.

The other one is assembly B including the main frame 2 to which the column body 1 may be connected. The jacking device 51, the battery box body 4, the pump station 53 and the controller 52 may be all part of this assembly B. Specifically, the jacking device 51 may use parts such as oil cylinders, and the pump station 53 may be used to supply oil to the jacking device. Both the pump station 53 and the controller 52 can be fixedly connected to the main frame 2 through a connecting piece. With the operation of the jacking device 51, the column body 1 and the fork 31 may be lifted in the vertical direction.

In this case, as mentioned above, assembly A may include the handle 32 and the drive wheel assembly 33, while assembly B may include the elements such as jacking device 51, the controller 52, the pump station 53, the main frame 2, the column body. Relative rotation may occur between assembly A and assembly B during operation steering, but there may be no relative rotation between the elements of assembly B.

This design can make the pump station 53, the controller 52 and the jacking device 51 not as rotating parts, but as static parts during the steering process, with less wear and less prone to failure or damage. On the other hand, these parts may be not rotated, so it may be not easy to cause the risk of hurting hands for the operator. Moreover, because the pump station 53, the controller 52 and the jacking device 51 and the battery box 4 do not rotate relatively, where the cables connected each other among the various elements can remain relatively stationary, and the cables may be not easily broken or damaged.

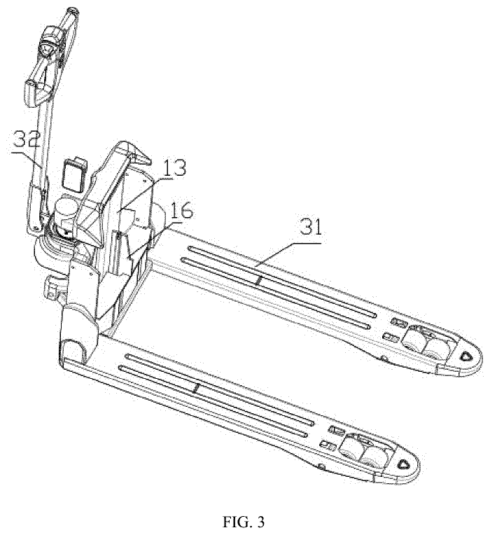

As shown in FIGS. 1, 2 and 3, the column body 1 may include an upper roof plate 11, two side plates 12 on both sides and a back plate 13, and also include a cover 15. The upper roof plate 11, the side plates 12, the back plate 13 and the cover 15 can cooperate with one another to form an accommodating space, and the jacking device 51, the controller 52 and the pump station 53 may be installed in this accommodating space. Due to the presence of these packaged elements, the elements, e.g. the jacking device 51, the controller 52, and the pump station 53, may be not visible on the outside, and the overall aesthetics of the vehicle may be improved.

Unlike the prior art, the space arrangement of the jacking device 51, the controller 52 and the pump station 53 may have been redesigned herein. As shown in FIG. 2, in the prior art, the controller 52, the jacking device 51, and the pump station 53 may be originally arranged in a row, and may be arranged in order from left to right. But in this embodiment, first of all, the jacking device 51 may be placed on the far right side of the drawing, that is, the position closest to the back plate 13, while the controller 52 and the pump station 53 may be located on the same side, these two elements position the same from the back plate 13.

Such a location design may have at least two beneficial effects. On one aspect, the jacking device 51 may be closer to the back plate 13, that is, there may be a contact point between the jacking device 51 and the lower surface of the upper roof plate 11, and the position of the contact point may be closer to the back plate 13. Under the lever effect, the distance between the contact point and the back plate 13 may be shorter, and the arm may be shorter, and the stability of the entire upper roof plate 11 may be stronger. The upper roof plate 11 may be less likely to be lifted to cause tilt or damage. On the other aspect, such a space arrangement makes the jacking device 51 located in the space enclosed by the upper roof plate 11, the side plates 12 and the back plate 13, and the controller 52 and the pump station 53 may be placed on the same side and at the same distance, In addition, the rotation range of the handle 32 and the drive wheel assembly 33 is also located in a space consisting of two side plates 12, so that the arrangement may be more compact. The length of the entire vehicle body may be shortened, and it has a smaller turning radius.

The column body 1 also adopts a reinforcement design. As shown in FIGS. 1, 2 and 3, the upper end of the side plates 12 may be connected to the upper roof plate 11 and the sides of the side plates 12 may be connected to the back plate 13. The side plates 12 may increase the structural strength of the upper roof plate 11 and can prevent the upper roof plate 11 deforming and tilt. A back reinforcement plate 16 may be provided on the back of the back plate 13, that is, the side away from the jacking device 51. The side of the reinforced plate 16 may be connected to the back plate 13 and the bottom surface may be connected to other connecting pieces, which also increases the back support of the back plate 13.

In this case, the back reinforcement plate 16 has two functions. One may be to support the structure of the back of the entire column body 1 during the lifting process, increasing its stability; the other may be to support and fix battery box as a support.

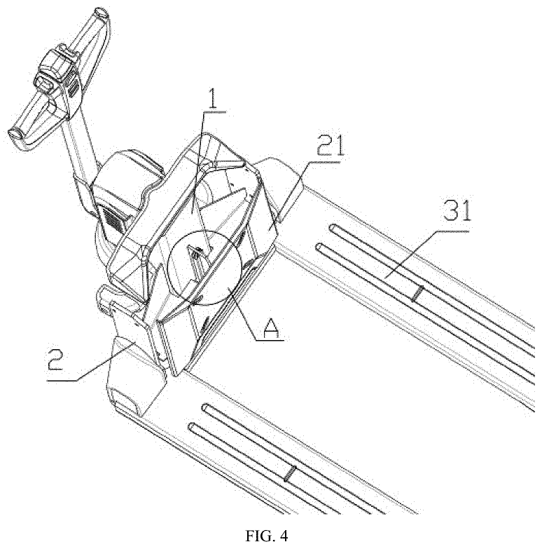

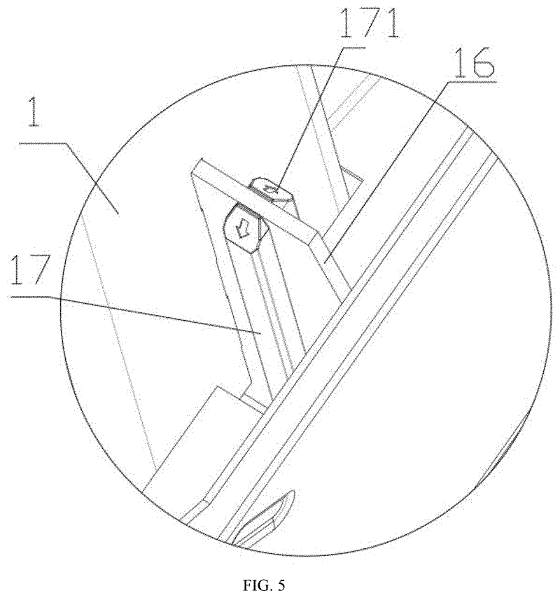

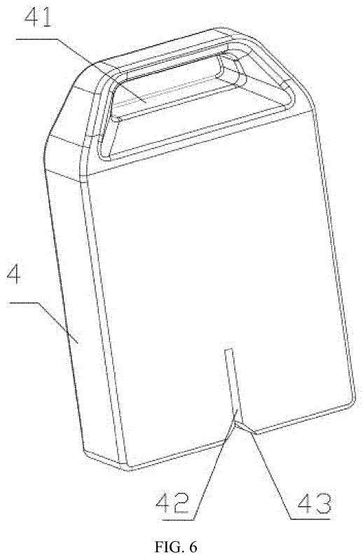

As shown in FIGS. 4, 5 and 6, the battery box may include a battery box body 4, a handle slot 41 may be provided at the upper position for the convenience of workers' handles, and a retention slot 42 may be provided at the bottom position, and the retention slot 42 may also extends in the vertical direction.

In order to facilitate the installation and sliding of the battery box body 4, a slide-in device may be provided. Specifically, a guide rail 17 may be provided on the back reinforcement plate 16, and a slide rail groove 44 that cooperates with the guide rail 17 may be also provided in the retention slot 42, and the entire battery box can slide in and out more smoothly.

Furthermore, since in the process of lowering the battery box held by the works, the field of view will be blocked by the battery box. In order to increase the smoothness and convenience of installation, a guide slope 171 may be provided on the guide rail 17 and the battery box body 4 close to the retention slot 42 may be correspondingly provided with a slide-in slope 43 as shown in FIG. 4. The guide slope 171 and the slide-in slope 43 may be both inclined and set at the same angle, and the slopes cooperate with each other to play the role of slide-in installation guide.

The battery parts in the battery box need to be electrically connected to the elements on the main frame 2, such as cables or other connectors, so the battery box box body 4 may be particularly provided with a connector opening 45, the position may be also set at the bottom near the retention slot 42.

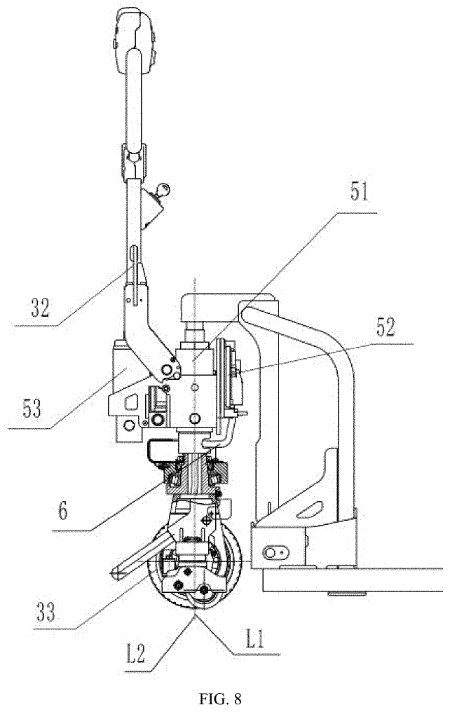

As shown in FIG. 8, FIG. 8 is a space arrangement in the first prior art. In this way, the handle 32 is connected to a connecting frame, the jacking device 51 is also an oil cylinder, and the oil cylinder is installed on the drive wheel directly. The centre line of the oil cylinder, that is, the cylinder axis L2, extends in the vertical direction. The vertical connection line between the position of the center of the drive wheel and the ground is the drive wheel center line L1. In this case, L1 and L2 coincide and are on a connecting line. In this structure, the position above the drive wheel is occupied by the oil cylinder, and the controller 52 is closer to direction of the fork. At this time, a connection hole needs to be opened in a part of the frame, and the drive wheel wire harness 6 comes out of this connection hole and to connect to the controller 52, it is necessary not only to guide the cable harness but also to bend it.

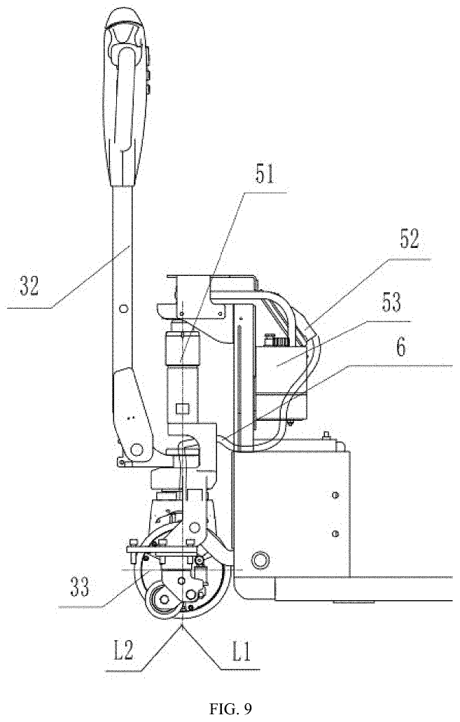

As shown in FIG. 9, FIG. 9 is a space arrangement of the second prior art. L1 and L2 are also coincident, and the oil cylinder is above the drive wheel, but there is a height gap between the two. The handle 32 is connected to the drive wheel. There are two such shortcomings. On the one hand, as in the first prior art, it is still necessary to make an outlet on the frame, the drive wheel wire harness is led out from this outlet, and connects to the controller 52 through multiple bends. On the other hand, during the rotation process, the relative rotation among the drive wheel, the oil cylinder, the pump station, the controller and other elements must occur.

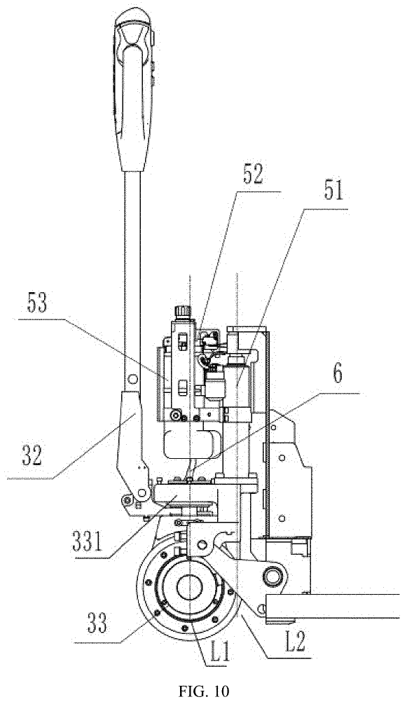

As shown in FIG. 10, FIG. 10 is the spatial arrangement of the technical solution. The two lines L1 and L2 do not coincide. Among them, the cylinder axis L2 my have been closer to the fork and farther away from the handle 32, which makes the drive wheel's upper position is not occupied, and the controller 52 may be above the drive wheel. In this way, in addition to the optimization space mentioned above and shortening the total length of the body, it has a good optimization for the connection of the wiring harness. In this technical solution, there may be no need to make additional holes/outlets for the connecting pieces, the drive wheel wire harness 6 may be directly led out through the rotary shaft hole, and may be connected to the controller 52, without bending, which facilitates maintenance of the wiring harness.

In addition, the three elements, such as the controller 52, the pump station 53 and the jacking device 51, in this connection form as a main body, and relative rotation does not occur, and the handle 32 may be directly connected to the drive wheel assembly 33.

In this connection mode, the position of the drive wheel assembly 33 will have greater torque. In order to match the torque, the bearings have been reinforced. One can use the double bearings design respectively at the upper and at the lower, or one can use a larger double-row bearing.

The drive wheel assembly 33 may include a drive wheel wheel body and a drive wheel frame 331 connected to the drive wheel wheel body. The rotary shaft hole may be located in the middle of the drive wheel frame 331, and the harness may be directly led out from the rotary shaft hole of the drive wheel frame 331. Regarding the specific installation of each element, the controller 52 and the pump station 53 may be both installed on the jacking device 51, and the lower end of the jacking device may be installed on the drive wheel frame 331, and the upper end may be in contact with the upper roof plate 11 of the column body 1. The drive wheel frame 331 may be provided with a hinged part, such as a circular rod or a rotating arm in the prior art, and the hinged part may be connected to the column body 1.

Because the battery is located in the frame, the controller, the oil pump in the prior art will rotate relative to the battery when it follows the drive wheel, and it will also rotate relative to the rotary shaft hole above the drive wheel, and the cable will bend and make stretch length shortened. In the present disclosure, the rotation displacements between the controller and the battery, as well as that between the oil pump and the battery may be eliminated. Only the vertical displacement and slight swing displacements during the original lifting may be retained. At the same time, there is no relative displacement between the controller and the rotary shaft hole, which may result in great improvement about bend and extending shortening of cable, and may effectively increase cable life and reduces failure rate.

1. An industrial vehicle, comprising a handle (32), a main frame (2) and a drive wheel assembly (33), wherein: the main frame (2) is mounted with a column body (1), the column body (1) comprises an upper roof plate (11), and the industrial vehicle further comprises a controller (52), a pump station (53), and a jacking device (51) abutting against the upper roof plate (11); in a horizontal direction, the jacking device (51) is farther away from the handle (32) than the drive wheel assembly (33).

2. The industrial vehicle according to claim 1, wherein the jacking device (51) is an oil cylinder.

3. The industrial vehicle according to claim 1, wherein a cylinder axis (L2) of the oil cylinder is farther away from the handle (32) than a drive wheel center line (L1) of a drive wheel body of the drive wheel assembly (33) in the horizontal direction.

4. The industrial vehicle according to claim 1, wherein the handle (32) is directly connected to the drive wheel assembly (33).

5. The industrial vehicle according to claim 4, wherein the controller (52), the pump station (53), and the jacking device (51) are installed on a drive wheel frame (331), the drive wheel frame (331) is connected to the column body (1) through a hinge structure, and a top of the jacking device (51) abuts against the upper roof plate (11).

6. The industrial vehicle according to claim 1, wherein the controller (52) is located above the drive wheel assembly (33) connected to the controller (52) through a drive wheel wiring harness (6), and the drive wheel wiring harness (6) derives from a rotary shaft hole at an upper position of the drive wheel assembly (33), an axis of the rotary shaft hole is concentric with a rotation center line of the drive wheel assembly (33), and the rotary shaft hole is located on the drive wheel frame (331).

7. The industrial vehicle according to claim 1, wherein the drive wheel assembly (33) comprises the drive wheel frame (331), and the drive wheel frame (331) is mounted with bearings that are double bearings distributed upside and downside.

8. The industrial vehicle according to claim 1, wherein the drive wheel assembly (33) comprises a drive wheel frame (331), and the drive wheel frame (331) is mounted with a bearing that is a single double-row bearing.

9. The industrial vehicle according to claim 1, wherein the column body (1) further comprises a back plate (13) connected to the upper roof plate (11), the jacking device (51) is closer to the back plate (13) than the controller (52) and the pump station (53).

10. The industrial vehicle according to claim 9, further comprising a battery box body (4) connected to the column body (1).

11. The industrial vehicle according to claim 9, wherein a distance between the controller (52) and the back plate (13) is the same as that between the pump station (53) and the back plate (13).

12. The industrial vehicle according to claim 9, wherein a side of the back plate (13) away from the jacking device (51) is provided with a back reinforcement plate (16) connected to the main frame (2), and the upper roof plate (11) and the back plate (13) are connected to two side plates (12).

13. The industrial vehicle according to claim 9, wherein the main frame (2) is connected to a fork (31) located on a side of the column body (1) away from the handle (32).

14. The industrial vehicle according to claim 9, wherein the two side plates (12), the upper roof plate (11), and the back plate (13) form a semi-enclosed space in which the jacking device (51) is mounted.

15. The industrial vehicle according to claim 9, further comprising a cover (15), wherein the cover (15), the two side plates (12), the upper roof plate (11), and the back plate (13) form an installation space for the controller (52), the pump station (53), and the jacking device (51).

16. The industrial vehicle according to claim 10, wherein the battery box body (4) comprises a retention slot (42) at a bottom, the back reinforcement plate (16) is used to extend into the retention slot (42), the retention slot (42) is provided with a slide rail groove (44), and the back reinforcement plate (16) is provided with a guide rail (17) sliding in the slide rail groove (44).

17. The industrial vehicle according to claim 16, wherein the battery box body (4) is provided with a slide-in slope (43) near the retention slot (42) inclinedly arranged, and the guide rail (17) is provided with a guide slope (171) at its uppermost position, and an inclination angle of the guide slope (171) matches that of the slide-in slope (43).

18. An industrial vehicle, comprising a handle (32), a main frame (2), and a drive wheel assembly (33), wherein: the main frame (2) is mounted with a column body (1), the column body (1) is connected with a fork (31), and the column body (1) comprises an upper roof plate (11), and the industrial vehicle further comprises a controller (52), a pump station (53), and a jacking device (51) abutting against the upper roof plate (11); in a horizontal direction, the jacking device (51) is closer to the fork (31) than the controller (32) and the pump station (53).

19. The industrial vehicle according to claim 18, wherein the handle (32) is connected to the drive wheel assembly (33), the controller (52), the pump station (53) and the jacking device (51) are connected with the column body (1).

20. The industrial vehicle according to claim 19, further comprising a battery box body (4) installed and connected to the column body (1); the battery box body (4) is provided with a slide-in slope (43) near a retention slot (42), and the slide-in slope (43) is inclinedly arranged, a guide rail (17) is provided with a guide slope (171) at an uppermost position, and an incline angle of the guide slope (171) matches that of the slide-in slope (43).
